(19) United States
(12) Patent Application Publication
(10) Pub. No.: US 2018/0365406 A1
(43) Pub. Date: Dec. 20, 2018

(54) METHODS AND SYSTEMS FOR PROVIDING ADVANCED SECURE BOOT FEATURES TO LIMITED-RESOURCE PERIPHERAL DEVICES BY USING A SECURE PROCESSOR

(71) Applicant: QUALCOMM Incorporated, San Diego, CA (US)

(72) Inventors: Or ELNEKAVEH, Kfar Vitkin (IL); Adi KAROLITSKY, Yokneam Elit (IL)

(21) Appl. No.: 15/628,453

(22) Filed: Jun. 20, 2017

(51) Int. Cl. G06F 21/44; G06F 21/57; G06F 21/70; H04L 9/08

(52) U.S. Cl. CPC G06F 21/44; G06F 21/575; H04L 2209/12; H04L 9/0819; G06F 21/70

(57) ABSTRACT

A method of authenticating software of a peripheral device may include obtaining, with a secure processor, a cryptographic key for a peripheral device; storing, on the secure processor, the cryptographic key for the peripheral device; sending, by the secure processor, the cryptographic key to the peripheral device; obtaining, by the secure processor, a software for the peripheral device; authenticating, by the secure processor, the software of the peripheral device to provide authenticated software; and sending, by the secure processor, the authenticated software to the peripheral device based on the cryptographic key.

### TECHNICAL FIELD

This invention relates to security in a computing device.

### BACKGROUND

A modern system on chip (SoC) is surrounded by many different subsystems, some of which are on the chip, while some of which are off the chip (peripheral devices). To reduce cost, peripheral devices often lack ROM code or flash memory, and have limited cryptographic hardware. As such, these peripheral devices often depend on the SoC's main application processor (a non-secure application processor) to provide them with the software needed to run. The application processor can use advanced cryptography to verify the peripheral device firmware image, but once verified, the firmware image is passed to the peripheral device over a non-secure channel, either with basic or non-existed cryptography.

Having limited resources at the disposal of the peripheral device may limit its verification of the firmware image, which may not be as good as what would otherwise be performed by the more advanced application processor. Having a trusted firmware on all system components, including peripheral devices, is crucial for overall platform security. Over the years, secure boot has become more and more advanced, with features like personalization, encryption, rollback protection, and the like. As such, extending such advanced secure boot features into some or all peripheral devices may be beneficial. However, implementing advanced secure boot features typically uses state-of-the-art secure services, which are often difficult to achieve in many subsystems, due to design constraints. For example, peripheral devices may lack replay-protected storage, lack read-only memory (ROM), and/or have limited hardware capabilities that may prevent such peripheral devices from implementing advanced secure boot features that may otherwise be available on a secure processor or the like. Having a disparity between application processor verification and peripheral device verification can create a weak link that can be exploited by an attacker.

### SUMMARY

In various embodiments, a client device may include (but is not limited to) a secure processor with processor-executable instructions to perform operations comprising: obtaining a cryptographic key for a peripheral device; storing the cryptographic key for the peripheral device; sending the cryptographic key to the peripheral device; obtaining a software for the peripheral device; authenticating the software of the peripheral device to provide authenticated software; and sending the authenticated software to the peripheral device based on the cryptographic key.

In some embodiments, the authenticating may comprise removing a security boot scheme of the obtained software to provide a different boot scheme for the authenticated software. In some embodiments, the authenticated software may be different from the software obtained by the secure processor. In further embodiments, the authenticated software may be free of a digital signature used to sign the software of the peripheral device.

In some embodiments, the software may be obtained from an external storage device. In some embodiments, the software comprises a firmware image. In some embodiments, the secure processor may be part of a system-on-chip (SoC); and the peripheral device is external to the SoC. In some embodiments, storing the cryptographic key for the peripheral device may comprise storing the cryptographic key in a non-volatile memory of the secure processor. In some embodiments, sending the cryptographic key to the peripheral device may comprise sending the cryptographic key to the peripheral device for storing in a non-volatile memory of the peripheral device.

In various embodiments, a method of authenticating software of a peripheral device may include (but is not limited to) obtaining, with a secure processor, a cryptographic key for the peripheral device; storing, on the secure processor, the cryptographic key for the peripheral device; sending, by the secure processor, the cryptographic key to the peripheral device; obtaining, by the secure processor, a software for the peripheral device; authenticating, by the secure processor, the software of the peripheral device to provide authenticated software; and sending, by the secure processor, the authenticated software to the peripheral device based on the cryptographic key.

In various embodiments, a client device may include (but is not limited to) means for obtaining a cryptographic key for a peripheral device; means for storing the cryptographic key for the peripheral device; means for sending the cryptographic key to the peripheral device; means for obtaining a software for the peripheral device; means for authenticating the software of the peripheral device to provide authenticated software; and means for sending the authenticated software to the peripheral device based on the cryptographic key.

In various embodiments, system on chip (SoC) for a client device may include (but is not limited to) a first processor; and a second processor coupled to the first processor. The second processor may be configured to generate a cryptographic key for a peripheral device; store the cryptographic key for the peripheral device; send the cryptographic key to the peripheral device to establish a secure channel between the second processor and the peripheral device; retrieve a firmware image from a storage device associated with the SoC; authenticate the retrieved firmware image to provide an authenticated firmware image; and send the authenticated firmware image to the peripheral device based on the cryptographic key.

In some embodiments, the first processor may comprise a main application processor and the second processor may comprise a secure processor that is separate from the main application processor. In some embodiments, the second processor may be configured to store the cryptographic key in a non-volatile memory of the secure processor. In some embodiments, the second processor may be configured to send the cryptographic key to the peripheral device for storing in a non-volatile memory of the peripheral device. In some embodiments, the storage device may be external to the SoC.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the embodiments.

FIG. 1 is a component block diagram of a client device according to various embodiments.

FIG. 2 is a process flow diagram illustrating a method for providing advanced secure boot features to limited-resource peripheral devices by using a secure processor in accordance with various embodiments.

FIG. 3 is a component block diagram of a client device suitable for use in various embodiments.

### DETAILED DESCRIPTION

Various embodiments will be described in detail with reference to the accompanying drawings. Wherever possible, the same reference numbers will be used throughout the drawings to refer to the same or like parts. References made to examples and implementations are for illustrative purposes, and are not intended to limit the scope of the embodiments or the claims.

In overview, various embodiments include methods and systems (e.g., client devices) configured to provide advanced secure boot features to limited-resource peripheral devices by using a secure processor.

In particular, various embodiments implement a secure processor, which can accommodate advanced secure boot features. The secure processor may be implemented to extend the same level of security provided by such advanced secure boot features to various peripheral devices, which typically have limited resources (e.g., lack of reply-protected storage, lack of ROM, limited hardware capabilities, etc.).

During manufacturing time, if no keys were previously exchanged with a peripheral device, a secure processer may auto-provision a shared secret or exchange asymmetric keys with one or more peripheral devices. The secure processor may generate a random key, store the generated random key, and associate the generated random key with the peripheral device. The generated random key may be then sent from the secure processor to the peripheral device. The peripheral device may store the key in a non-volatile memory (e.g., a fuse). Conversely, the peripheral device may generate an asymmetric key and send the key to the secure processor. Both sides may store their respective keys in respective non-volatile memories.

With a shared secret between the secure processor and the peripheral device, a secure channel may be implemented and established between the secure processor and the peripheral device with reduced hardware and software complexity.

Advanced secure boot features, such as personalization (per device image using different signatures and/or keys), encryption, rollback (or replay) protection (e.g., to protect against loading previous software versions), etc. can now be handled by the secure processor and extended to the peripheral device. As such, the peripheral device does not need to implement any of the mechanisms required for such security. Instead, the peripheral device can rely on the secure channel to load software provided by the secure processor. Moreover, with the secure processor in charge of loading the software (e.g., firmware) for the peripheral devices, attestation of the current security state is made easier. That is, strong cryptographic proof is provided that a peripheral device was loaded with a genuine firmware, according to one or more advanced secure boot requirements.

The terms “mobile computing device,” “wireless communication device,” and “client device” are used interchangeably herein to refer to any one or all of cellular telephones, smartphones, personal or mobile multi-media players, personal data assistants (PDAs), laptop computers, tablet computers, smartbooks, ultrabooks, palm-top computers, wireless electronic mail receivers, multimedia Internet enabled cellular telephones, wireless gaming controllers, drones, vehicle infotainment systems, Internet of Things (IoT) devices, and any other similar personal electronic devices which include a memory, a processor for which security may be important. While the various embodiments are particularly useful for mobile computing devices, such as smartphones, which have limited resources and run on battery, the embodiments are useful in any electronic device that includes a processor and executes application programs.

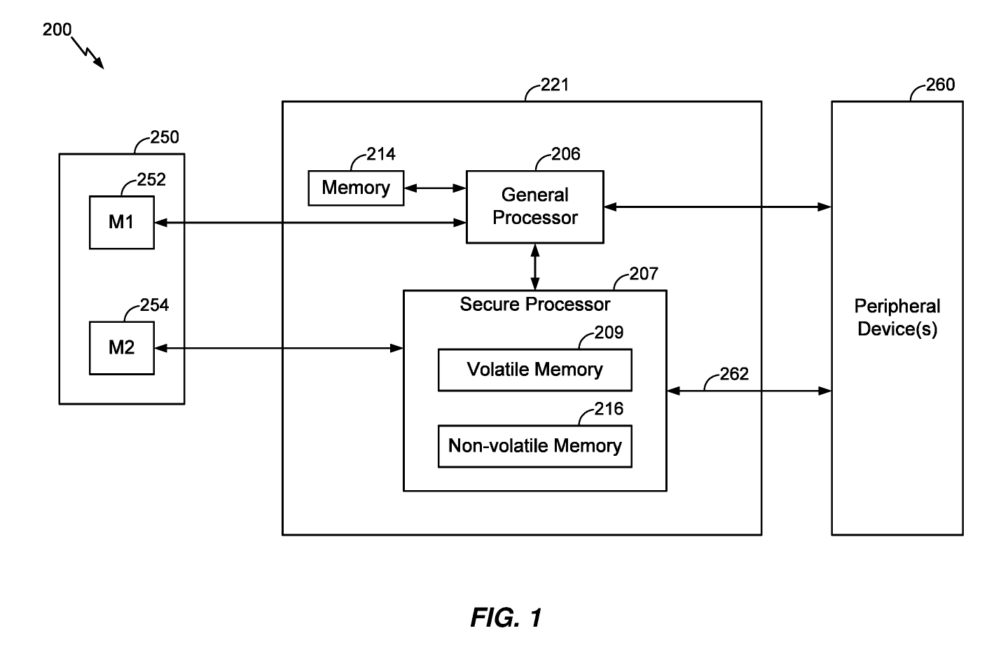

FIG. 1 is a component block diagram of a client device 200 (which may also be referred to a mobile communication device) suitable for implementing various examples.

The client device 200 may include at least one controller, such as a general-purpose processor 206 (which may also be referred to as a main application processor), which may be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The client device 200 may also include a secure processor 207 (or cryptoprocessor) that may be a separate secure processing unit with dedicated hardware, software, firmware, memory, etc., to create an isolated execution environment with higher level of security than the rest of a system on chip (SoC) 221 on which the secure processor 207 is provided. The secure processor 207 may allow for security procedures, such as (but not limited to) running trusted applications, utilizing keys, verifying signatures, and perform the functions herein described. In some embodiments, the secure processor 207 may include a volatile memory 209 that can be used for computation isolated from the rest of the SoC 221.

The client device 200 may also include a secure non-volatile memory 216 coupled to or part of the secure processor 207. The secure non-volatile memory 216 may include on one or more fuses or an integrated flash. As discussed, the non-volatile memory 216 may store a cryptographic key generated by the secure processor 207 (or a peripheral device 260).

In some examples, one or more of the general-purpose processor 206, the secure processor 207, the memory 214, the secure memory 216 may be included in the client device 200 as the system on chip (SoC) 221. In further embodiments, one or more of the peripheral device(s) 260 may be external to the SoC 221, but still in communication with the components (e.g., the general-purpose processor 206, the secure processor 207, etc.) of the client device 200. Non-limiting examples of the peripheral device(s) 260 may include a Wi-Fi module, a near-field communication (NFC) module, a Bluetooth module, a camera module, a biometric sensor, an input device (e.g., physical keyboard), touch controller module, display module, audio/video-processing modules, etc.

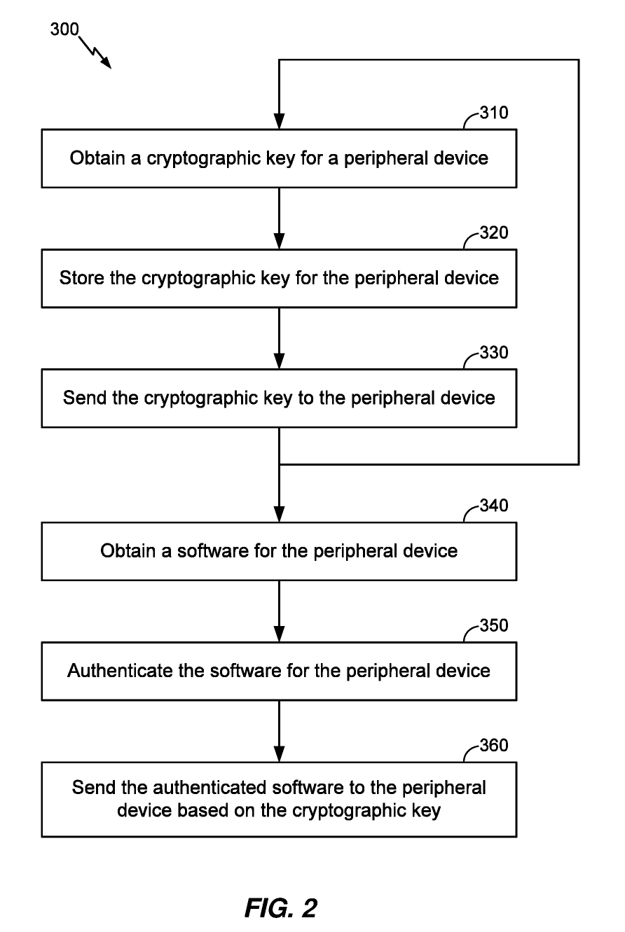

FIG. 2 illustrates a method 300 of providing advanced secure boot features to limited-resource peripheral devices by using a secure processor according to various embodiments. With reference to FIGS. 1 and 2, the method 300 may be implemented by one or more processors (e.g., the secure processor 207, the general-purpose processor 206 when operating in a secure mode, and/or the like) of a client device (e.g., the client device 200). According to various embodiments, the method 300 (or parts thereof) may be implemented during assembly of the client device 200. However, the method 300 (or parts thereof) may be implemented at any suitable time.

In blocks 310, the secure processor 207 may generate or otherwise obtain a cryptographic key, such as a symmetric key, for the peripheral device 260.

In block 320, the secure processor 207 may store the cryptographic key for the peripheral device 260 in the secure non-volatile memory 216 (e.g., one or more fuses or integrated flash). In other embodiments, the cryptographic key for the peripheral device 260 may be cryptographically protected in the external storage device 250 (e.g., second memory M2 254) or other suitable location (e.g., the memory 214).

In block 330, the secure processor 207 may send the cryptographic key to the peripheral device 260. The peripheral device 260 may then store the cryptographic key in a non-volatile memory, such as one or more fuses (e.g., a programmable read-only memory (PROM)) of the peripheral device 260. Thus, the cryptographic key is now shared between the secure processor 207 and the peripheral device 260. With a shared secret between the secure processor 207 and the peripheral device 260, a secure channel 262 may be implemented and established between the secure processor 207 and the peripheral device 260 with reduced hardware or software complexity.

The secure processor 207 may repeat blocks 310-330 for each peripheral device 260. Thus, the secure processor 207 may generate and share a unique cryptographic key for each peripheral device 260, thus establishing a respective secure channel 262 with each peripheral device 260. Moreover, because each cryptographic key is unique to each peripheral device 260, the secure channels 262 are isolated and the peripheral devices 260 cannot impersonate another peripheral device 260.

In block 340, the secure processor 207 may obtain a software (e.g., a firmware image or the like) for the peripheral device 260. In particular embodiments, the secure processor 207 may obtain the software from an external memory 250 or storage device, such as (but not limited to) a flash memory.

The external storage device 250 may include software for one or more components of the client device 200. For instance, the external storage device 250 may include a first memory M1 on which the software for the peripheral device 260 may be stored. In further embodiments, the external storage device 250 may include a second memory M2 for which software for one or more other peripheral devices 260 and/or the general-purpose processor 206 may be stored. For simplicity, the external storage device 250 is illustrated as have multiple memories M1, M2 for storing software for respective peripheral devices. However, it should be obvious that any number of external storage devices 250 (for storing software for any number of peripheral devices) may be provided with each external storage device 250 providing software for a respective peripheral device 260. That is, software for each peripheral device 260 may be provided on a different storage device 250.

In block 350, the secure processor 207 may authenticate the obtained software for the peripheral device 260. In some embodiments, after authenticating the obtained software, the secure processor 207 may convert an obtained firmware image (e.g., from the external memory 250) to a simplified boot image by removing or replacing a security boot scheme from the obtained firmware image (e.g., removing a digital signature used to sign the obtained firmware image).

In block 360, the secure processor 207 may send the authenticated software to the peripheral device 260 based on the cryptographic key for loading by the peripheral device 260. That is, the secure processor 207 may send the authenticated software to the peripheral device 260 over the secure channel to allow the peripheral device 260 to load the authenticated software. Thus, for instance in some embodiments, the secure processor 207 may send the simplified boot image via the secure channel to the peripheral device 260 to allow the peripheral device 260 to load the simplified boot image. Because the secure processor 207 has already authenticated the software at block 350, this boot scheme information may not be needed by the peripheral device 207 to authenticate the software.

Accordingly, advanced secure boot features, such as personalization, encryption, rollback protection, etc. can now be handled by the secure processor 207, and extended to the peripheral device 260 (i.e., these features can be performed by the secure processor 207 on behalf of the peripheral device 260). As such, the peripheral device 260 does not need to implement the mechanisms required for advanced secure boot. Instead, the peripheral device 260 can rely on the secure channel to load software provided by the secure processor 207. Moreover, with the secure processor 207 in charge of loading the software (e.g., firmware) for the peripheral devices 260, attestation of the current security state is made easier. That is, strong cryptographic proof is provided that a peripheral device 260 was loaded with a genuine firmware, according to one or more advanced secure boot requirements.

As discussed, according to various embodiments, the method 300 may be performed by the secure processor 207. However, in other embodiments, the method 300 (or parts thereof) may be performed by the peripheral device 260. For instance, in some embodiments, the peripheral device 260 may generate or otherwise obtain its own cryptographic key and send the cryptographic key to the secure processor 207 to thereby establish the secure channel between the peripheral device 260 and the secure processor 207.

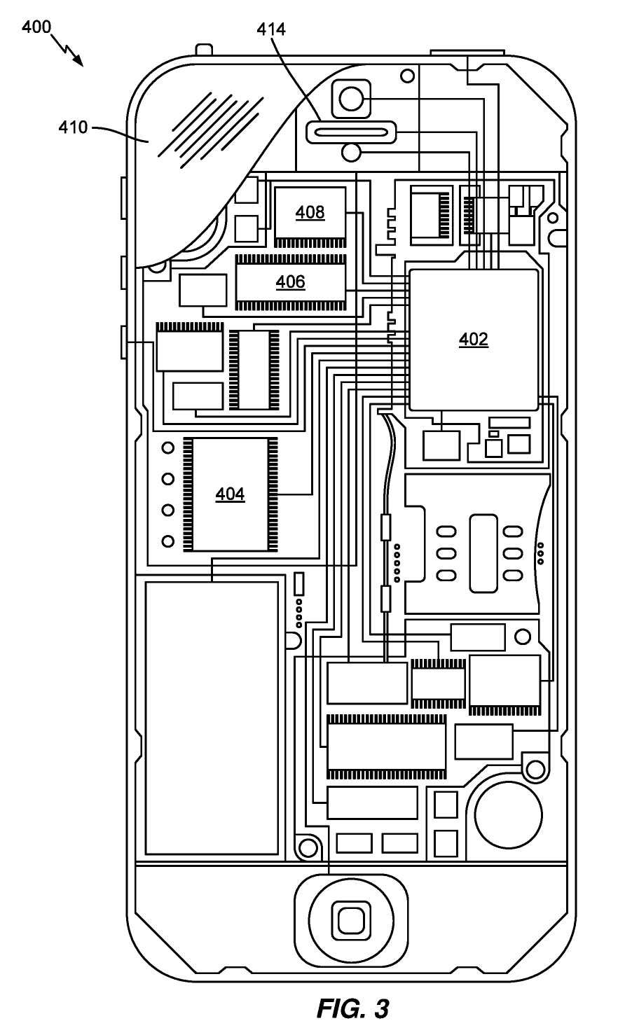

The various embodiments may be implemented on a variety of client devices (e.g., 200 in FIG. 1), an example of which is illustrated in FIG. 3 in the form of a smartphone 400. With reference to FIGS. 1-3, the smartphone 400 may include (but is not limited to) a processor 402 coupled to internal memory 404, a display 410, and to a speaker 414. Additionally, the smartphone 400 may include an antenna for sending and receiving electromagnetic radiation that may be connected to a wireless data link and/or cellular telephone transceiver 408 coupled to the processor 402.

A typical smartphone 400 may also include a sound encoding/decoding (CODEC) circuit 406, which digitizes sound received from a microphone into data packets suitable for wireless transmission and decodes received sound data packets to generate analog signals that are provided to the speaker to generate sound. Also, one or more of the processor 402, wireless transceiver 408 and CODEC 406 may include a digital signal processor (DSP) circuit (not shown separately).

The processor 402 may be any programmable microprocessor, microcomputer or multiple processor chip or chips that can be configured by software instructions (applications) to perform a variety of functions, including the functions of the various embodiments described below. In some smartphones 400, multiple processors 402 may be provided, such as one processor (e.g., a general-purpose processor or main application processor) dedicated to processing and executing software and one processor dedicated to other functions, such as security. Typically, software applications may be stored in the internal memory 404 before they are accessed and loaded into the processor 402. The processor 402 may include or be associated with internal memory sufficient to store the application software instructions.

Many different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), global system for mobile communications (GSM), universal mobile telecommunications system (UMTS), 3GSM, general packet radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iden). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Computer program code or “program code” for execution on a programmable processor for carrying out operations of the various embodiments may be written in a high-level programming language such as C, C++, C#, Smalltalk, Java, JavaScript, Visual Basic, a Structured Query Language (e.g., Transact-SQL), Perl, Objective-C, Swift, or in various other programming languages. Program code or programs stored on a computer readable storage medium as used in this application may refer to machine language code (such as object code) whose format is understandable by a processor.

Many computing device operating systems are organized into a user space (where non-privileged code runs) and a kernel space (where privileged code runs). This separation is of particular importance in Android® and other general public license (GPL) environments where code that is part of the kernel space must be GPL licensed, while code running in the user-space may not be GPL licensed. It should be understood that the various software components or modules discussed here may be implemented in either the kernel space or the user space, unless expressly stated otherwise.

The foregoing method descriptions and the process flow diagrams are provided merely as illustrative examples, and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

As used in this application, the terms “component,” “module,” “system,” “engine,” “generator,” “manager,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The term “runtime system” may be used in this application to refer to a combination of software and/or hardware resources in a computing device that support the execution of an application program in that device. For example, a runtime system may include all or portions of the computing device's processing resources, operating systems, library modules, schedulers, processes, threads, stacks, counters, and/or other similar components. A runtime system may be responsible for allocating computational resources to an application program, for controlling the allocated resources, and for performing the operations of the application program. The runtime system may execute or perform all or portions of a software application in one or more hardware processing units (e.g., processor, a processing core, etc.) via processes, threads, or tasks.

The various illustrative logical blocks, modules, circuits, and algorithm steps described about the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments. Various modifications to these embodiments will be clear to those skilled in the art, and the generic principles defined herein may be applied to other embodiments without departing from the spirit or scope of the disclosure. Thus, the various embodiments are not intended to be limited to the embodiments shown herein but are to be accorded the widest scope consistent with the following claims and the principles and novel features disclosed herein.

What is claimed is:

1. A client device, comprising:
a secure processor with processor-executable instructions to perform operations comprising:
obtaining a cryptographic key for a peripheral device;
storing the cryptographic key for the peripheral device;
sending the cryptographic key to the peripheral device;
obtaining a software for the peripheral device;
authenticating the software of the peripheral device to provide authenticated software; and
sending the authenticated software to the peripheral device based on the cryptographic key.

2. The client device of claim 1, wherein the authenticating further comprises removing a security boot scheme of the obtained software to provide a different boot scheme for the authenticated software.

3. The client device of claim 1, wherein the authenticated software is different from the software obtained by the secure processor.

4. The client device of claim 3, wherein the authenticated software is free of a digital signature used to sign the software of the peripheral device.

5. The client device of claim 1, wherein the software is obtained from an external storage device.

6. The client device of claim 1, wherein the software comprises a firmware image.

7. The client device of claim 1,
wherein the secure processor is part of a system-on-chip (SoC); and
wherein the peripheral device is external to the SoC.

8. The client device of claim 1, wherein storing the cryptographic key for the peripheral device comprises storing the cryptographic key in a non-volatile memory of the secure processor.

9. The client device of claim 1, wherein sending the cryptographic key to the peripheral device comprises sending the cryptographic key to the peripheral device for storing in a non-volatile memory of the peripheral device.

10. A method of authenticating software of a peripheral device, the method comprising:
obtaining, with a secure processor, a cryptographic key for the peripheral device;
storing, on the secure processor, the cryptographic key for the peripheral device;
sending, by the secure processor, the cryptographic key to the peripheral device;
obtaining, by the secure processor, a software for the peripheral device;
authenticating, by the secure processor, the software of the peripheral device to provide authenticated software; and
sending, by the secure processor, the authenticated software to the peripheral device based on the cryptographic key.

11. The method of claim 10, wherein the authenticating comprises removing a security boot scheme of the obtained software to provide a different boot scheme for the authenticated software.

12. The method of claim 10, wherein the authenticated software is different from the software obtained by the secure processor.

13. The method of claim 12, wherein the authenticated software is free of a digital signature used to sign the software of the peripheral device.

14. The method of claim 10, wherein the software is obtained from an external storage device.

15. The method of claim 10, wherein the software comprises a firmware image.

16. The method of claim 10,
wherein the secure processor is part of a system-on-chip (SoC); and
wherein the peripheral device is external to the SoC.

17. The method of claim 10, wherein storing the cryptographic key for the peripheral device comprises storing the cryptographic key in a non-volatile memory of the secure processor.

18. The method of claim 10, wherein sending the cryptographic key to the peripheral device comprises sending the cryptographic key to the peripheral device for storing in a non-volatile memory of the peripheral device.

19. A client device comprising:
means for obtaining a cryptographic key for a peripheral device;
means for storing the cryptographic key for the peripheral device;
means for sending the cryptographic key to the peripheral device;
means for obtaining a software for the peripheral device;
means for authenticating the software of the peripheral device to provide authenticated software; and
means for sending the authenticated software to the peripheral device based on the cryptographic key.

20. The client device of claim 19, wherein the authenticating comprises removing a security boot scheme of the obtained software to provide a different boot scheme for the authenticated software.

21. The client device of claim 19, wherein the software is obtained from an external storage device.

22. The client device of claim 19, wherein the software comprises a firmware image.

23. A system on chip (SoC) for a client device, the SoC comprising:
a first processor; and
a second processor coupled to the first processor, the second processor configured to:
generate a cryptographic key for a peripheral device;
store the cryptographic key for the peripheral device;
send the cryptographic key to the peripheral device to establish a secure channel between the second processor and the peripheral device;
retrieve a firmware image from a storage device associated with the SoC;
authenticate the retrieved firmware image to provide an authenticated firmware image; and
send the authenticated firmware image to the peripheral device based on the cryptographic key.

24. The SoC of claim 23, wherein the first processor comprises a main application processor and the second processor comprises a secure processor that is separate from the main application processor.

25. The SoC of claim 23, wherein the second processor is configured to store the cryptographic key in a non-volatile memory of the secure processor.

26. The SoC of claim 23, wherein the second processor is configured to send the cryptographic key to the peripheral device for storing in a non-volatile memory of the peripheral device.

27. The SoC of claim 23, wherein the storage device is external to the SoC.
